(19) United States
(12) Patent Application Publication
(10) Pub. No.: US 2021/0195895 A1
(43) Pub. Date: Jul. 1, 2021

(54) COMPOSITIONS AND METHODS FOR IMPROVING THE DROUGHT TOLERANCE OF PLANTS

(71) Applicant: Smithers-Oasis Company, Kent, OH (US)

(72) Inventors: Sanalkumar KRISHNAN, Tallmadge, OH (US); Vijaya K. RAPAKA, Stow, OH (US); James P. DALY, Cottageville, SC (US)

(21) Appl. No.: 17/202,825

(22) Filed: Mar. 16, 2021

Related U.S. Application Data
(63) Continuation-in-part of application No. PCT/US2019/051338, filed on Sep. 16, 2019.
(60) Provisional application No. 62/732,212, filed on Sep. 17, 2018.

(51) Int. Cl. A01N 43/08; A01N 37/44; A01N 43/36; A01N 25/30

(52) U.S. Cl. CPC A01N 43/08; A01N 25/30; A01N 43/36; A01N 37/44

(57) ABSTRACT

Compositions and methods for extending the shelf life, quality and performance of plants under moisture stress. The compositions include an antioxidant and an osmolyte dissolved in water. The compositions can be prepared from a dry or liquid concentrate. When prepared from a liquid concentrate, the compositions also preferably include a wetting agent, an emulsifier a preservative and a colorant. In a preferred method of the invention, the compositions are formulated for application via sub-irrigation, drench and/or drip, or are formulated for application via overhead. The compositions maximize water saturation ability (container capacity), and provide better water retention and better rewetting ability. The compositions also improve water usage efficiency and reduce watering frequency requirements. These affects last multiple watering cycles, thereby providing product efficacy.

### CROSS-REFERENCE TO RELATED APPLICATIONS

This application is a continuation-in-part of International Application No. PCT/US2019/051338, filed Sep. 16, 2019, and claims priority to U.S. Provisional Pat. App. Ser. No. 62/732,212, filed Sep. 17, 2018.

### BACKGROUND OF INVENTION

### Field of Invention

The present invention relates to a composition and method for improving the drought tolerance of plants, which can be potted plants, bedding plants, vegetable transplants, and other horticulture, food, and agricultural crops.

### Description of Related Art

Potted plants, bedding plants, vegetable transplants, and other horticulture, food, and agricultural crops sometimes exhibit diminished quality (e.g., flower shrinkage and/or wilting) due to water stress. This can occur, for example, during transport, after transport and/or during display for sale at retail or after transplant. For example, watering potted plants at the retail store level can be problematic for retailers, particularly during busy holiday seasons such as Mother's Day, Valentine's Day, Thanksgiving and Christmas. During such times, it is difficult for retailers to allocate sufficient time and labor for watering plants. Wilting due to dehydration is one the biggest drivers for customer dissatisfaction, and it can result in enormous losses at the retail level. Another example involves young plants propagated from seed or cuttings incurring shock and stress when transplanted into a growing container, landscape or field. Any delay in watering through irrigation or rain can make the young plants wilt, and can jeopardize their survival.

### BRIEF SUMMARY OF THE INVENTION

In view of the foregoing, the present invention is directed toward compositions and methods for improving the drought tolerance of plants. The compositions and methods extend the shelf life, quality, and performance of plants including, but not limited to, potted plants, bedding plants, vegetable transplants, and other horticulture, food, and agricultural crops under moisture stress. The compositions are applied as liquid formulations, which can be used to treat plants before they leave a grower's production site and/or at the retailer level to extend the shelf life of the plants. The compositions can also be applied to plants before and/or after transplant to improve the survival and performance of the transplants. The compositions maintain the quality of the plants by improving water retention and hydration through the supply chain and by extending the shelf life of the plants.

The compositions comprise an antioxidant and an osmolyte, which are dissolved in water. In some applications, the antioxidant and osmolyte are preferably present at about a 50:50 weight ratio. But they can be present at weight ratios of from 10:90 to 90:10. In some applications (e.g., when the compositions are applied via sub-irrigation, drench or drip), the antioxidant and the osmolyte are each preferably present at a concentration of about 5 grams per liter, which allows the composition to be used to saturate the root zone of the plants in growing media. In other applications (e.g., when the compositions are applied by overhead spraying), the antioxidant may be present in a lower concentration than the osmolyte (e.g. about 0.25 gram of antioxidant and about 5 grams of osmolyte per liter).

In some embodiments, the composition are prepared from a liquid concentrate. The dilution ratio of concentrate to water is preferably 1:50. But other ratios (e.g., up to about 1:200) can be used, subject to the solubility of the components. When the compositions are prepared from a liquid concentrate, the compositions optionally, but preferably, further comprise, one or more (or all) of a wetting agent, an emulsifier, a preservative and a colorant. The antioxidant and osmolyte can also be provided as a dry concentrate (e.g., as a pill, encapsulate, loose powder or a powder contained in a sachet), which can be dissolved in water to the appropriate concentration for use.

In a preferred method of the invention, the compositions are applied via sub-irrigation, drench or drip. But, as noted above, the compositions may be formulated for application by other means (e.g., overhead).

The compositions provide several benefits over known compositions. For example, the compositions maximize water saturation ability (container capacity) and provide better water retention and better rewetting ability. The compositions also improve water usage efficiency and reduce watering frequency requirements. These effects last at least two watering cycles, thereby providing product efficacy. These benefits result in labor savings and increase sales revenues at retail.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

With reference to the accompanying drawing figures, please note that:

FIG. 1 is a photograph showing control poinsettias after 14 days of initiation of a drought stress study;

FIG. 2 is a photograph showing poinsettias treated with a composition according to the invention after 14 days of initiation of a drought stress study;

FIG. 3 is a photograph showing control indoor potted roses after 8 days of initiation of a drought stress study;

FIG. 4 is a photograph showing indoor potted roses treated with a composition according to the invention after 8 days of initiation of a drought stress study;

FIG. 5 is a photograph showing control Spathyphyllum after 10 days of initiation of a drought stress study;

FIG. 6 is a photograph showing Spathyphyllum treated with a composition according to the invention after 10 days of initiation of a drought stress study;

FIG. 7 is a photograph showing control cilantro after 4 days of initiation of a drought stress study;

FIG. 8 is a photograph showing cilantro treated with a composition according to the invention after 4 days of initiation of a drought stress study;

FIG. 9 is a photograph showing control cilantro after 5 days of initiation of a drought stress study;

FIG. 10 is a photograph showing cilantro treated with a composition according to the invention after 5 days of initiation of a drought stress study;

FIG. 11 is a photograph showing control spearmint after 4 days of initiation of a drought stress study;

FIG. 12 is a photograph showing spearmint treated with a composition according to the invention after 4 days of initiation of a drought stress study;

FIG. 13 is a photograph showing control basil after 9 days of initiation of a drought stress study;

FIG. 14 is a photograph showing basil treated with a composition according to the invention after 9 days of initiation of a drought stress study;

FIG. 15 is a photograph showing control basil after 10 days of initiation of a drought stress study;

FIG. 16 is a photograph showing basil treated with a composition according to the invention after 10 days of initiation of a drought stress study;

FIG. 17 is a photograph showing control “Christmas Spirit” poinsettia rooted cuttings 4 days of initiation of a drought stress study;

FIG. 18 is a photograph showing “Christmas Spirit” poinsettia rooted cuttings treated with a composition according to the invention 4 days of initiation of a drought stress study;

FIG. 19 is a photograph showing control “Christmas Spirit” poinsettia rooted cuttings 5 days of initiation of a drought stress study;

FIG. 20 is a photograph showing “Christmas Spirit” poinsettia rooted cuttings treated with a composition according to the invention 6 days of initiation of a drought stress study;

FIG. 21 is a photograph showing control “Christmas Spirit” poinsettia rooted cuttings 6 days of initiation of a drought stress study;

FIG. 22 is a photograph showing “Christmas Spirit” poinsettia rooted cuttings treated with a composition according to the invention 6 days of initiation of a drought stress study;

FIG. 23 is a photograph showing control “Maren” poinsettia rooted cuttings 4 days of initiation of a drought stress study;

FIG. 24 is a photograph showing “Maren” poinsettia rooted cuttings treated with a composition according to the invention 4 days of initiation of a drought stress study;

FIG. 25 is a photograph showing control “Maren” poinsettia rooted cuttings 5 days of initiation of a drought stress study;

FIG. 26 is a photograph showing “Maren” poinsettia rooted cuttings treated with a composition according to the invention 5 days of initiation of a drought stress study;

FIG. 27 is a photograph showing control “Maren” poinsettia rooted cuttings 6 days of initiation of a drought stress study;

FIG. 28 is a photograph showing “Maren” poinsettia rooted cuttings treated with a composition according to the invention 6 days of initiation of a drought stress study;

FIG. 29 is a photograph showing the control “Christmas Spirit” poinsettia rooted cuttings shown in FIG. 21 1 day after re-watering following a drought stress study;

FIG. 30 is a photograph showing the “Christmas Spirit” poinsettia rooted cuttings treated with a composition according to the invention shown in FIG. 22 1 day after re-watering following a drought stress study;

FIG. 31 is a photograph showing the control “Maren” poinsettia rooted cuttings shown in FIG. 27 1 day after re-watering following a drought stress study; and

FIG. 32 is a photograph showing the “Maren” poinsettia rooted cuttings treated with a composition according to the invention shown in FIG. 28 1 day after re-watering following a drought stress study.

### DETAILED DESCRIPTION OF THE INVENTION

Compositions according to the invention comprise an antioxidant and an osmolyte dissolved in water. In some applications, the antioxidant and osmolyte are preferably present in the concentration at a 50:50 ratio by weight. But the antioxidant and osmolyte can be present at ratios (all by weight) from about 10:90 to about 90:10 relative to each other, or from about 25:75 to about 75:25 relative to each other. For certain applications (e.g., when the compositions are applied via sub-irrigation, drench or drip), the antioxidant and osmolyte are preferably present in weight ratios of from about 40:60 to about 60:40 relative to each other. In other applications (e.g., when the compositions are applied overhead), the antioxidant and osmolyte are preferably present in weight ratios of from about 10:90 to about 30:70 relative to each other.

The antioxidant is preferably one or more selected from the group consisting of erythorbic acid, ascorbic acid and/or their isomers (e.g., L-ascorbic acid, D-ascorbic acid, L-erythorbic acid and D-erythorbic acid) and salts (e.g., calcium ascorbate, sodium ascorbate, potassium ascorbate, magnesium ascorbate, calcium erythorbate, sodium erythorbate and potassium erythorbate), dehydroascorbic acid and glutathione. For certain applications (e.g., when the compositions are applied via sub-irrigation, drench or drip), the antioxidant is preferably present in the composition at a concentration of about 5 grams per liter. For other applications (e.g., when the compositions are applied overhead), the antioxidant is preferably present in the composition at a concentration of about 0.25 grams per liter.

The osmolyte is preferably selected from the group consisting of betaine (N, N, N-trimethylglycine), proline, and glycine, all of which are powders. Betaine is the presently most preferred osmolyte for use in the invention. The osmolyte is also preferably present in the composition at a concentration of about 5 grams per liter (this is preferred for all application methods).

In one embodiment, the composition is prepared from a liquid concentrate. The dilution ratio of concentrate to water is preferably 1:50. But other ratios (e.g., up to about 1:200) can be used, if desired. When the composition is prepared from a liquid concentrate, the composition optionally, but preferably, further comprises, one or more (or all) of a wetting agent, an emulsifier, a preservative and a colorant.

Erythorbic acid and betaine are both powders. Thus, it is possible to prepare a dry concentrate (e.g., as a pill, encapsulate, loose powder or a powder contained in a sachet), which can be dissolved in water to the appropriate concentration for use. But in view of time and ease of use, liquid concentrates are presently preferred.

When the composition is prepared from a concentrate (liquid or dry), deionized water is preferably used. Tap water can also be used provided it does not contain levels of chlorine and/or other compounds that can deactivate the antioxidant and osmolyte.

When the composition is prepared from a liquid concentrate, it is preferable for the concentrate to further comprise one or more (or all) of a wetting agent, an emulsifier, a preservative and a colorant. The wetting agent can help the composition saturate growing media. The emulsifier can help keep the wetting agent dispersed in the concentrate. The preservative can protect against spoilage during storage. And the colorant can maintain the color of the composition over time.

A variety of suitable growing media wetting agents are known in the art. In a preferred embodiment, the wetting agent is a non-ionic surfactant such as a polyoxypropylene-polyoxyethylene block copolymer. A commercially available wetting agent is sold by Smithers-Oasis Company under the SOAX® trademark. The wetting agent improves dispersion of the composition in growing media, and also improves uptake of the composition by plants.

The emulsifier is used predominantly to prevent separation of the wetting agent over time. In a preferred embodiment the emulsifier is polyoxyethylene sorbitan monooleate (e.g., TWEEN® 80). But other emulsifiers known in the art can be used.

In a preferred embodiment, the preservative is ISOCIL® RW 14, which is available from Lonza Inc of Allendale, N.J. The preservative functions as a biocide, which prevents spoilage of the liquid concentrate during storage. It will be appreciated that other biocides/preservatives can be used.

The composition can include other additives such as, for example, gamma-aminobutyric acid (GABA) (CAS Number 56-12-2). GABA can be present in any amount up to a limit of toxicity. In one embodiment, GABA is used at a concentration of about 5 grams per liter. The composition can further comprise one or more pH adjusters or pH buffers. The pH of the composition is low due to the acid component, but increasing the pH can neutralize the acid component and thereby reduce efficacy.

The liquid concentrate, when formed, typically exhibits a light, golden honey-like appearance. However, the appearance of the composition will change over time and as a function of temperature, time, and exposure to light and thus take on a darker appearance. The color change has no appreciable effect on the efficacy of the composition. But to control and maintain the appearance of the liquid concentrate over time, one can add a colorant such as ACID STABLE AQUA 5270, which is available from Koch Color of Bennett, Colo.

The composition can be provided in a ready-to-use format. However, in larger scale applications, it is desirable to provide the composition in concentrated form (e.g., as a powder or as a liquid concentrate). When provided as a liquid concentrate, the composition is preferably diluted at a ratio of about 1:50 with water. Again, the water used is preferably not highly chlorinated or treated inasmuch as chlorine can deactivate or degrade the effectiveness of the composition in use.

The compositions can be formulated for application via sub-irrigation, drench or drip, but may also be formulated for overhead application. Depending on plant type, toxicity might appear on foliage or flowers from overhead application if the antioxidant concentration is too high. The potential for can be alleviated by surface washing with clear water after application (e.g., if the concentration of the antioxidant is deemed to be too high).

The composition provides several benefits over known compositions. For example, it maximizes water saturation ability (container capacity), provides better water retention and better rewetting ability. It also improves water usage efficiency and reduces watering frequency requirements. These effects last at least two watering cycles, thereby providing product efficacy. These benefits result in labor savings and increase sales revenues.

Table 1 below provides mass ranges in grams of materials used to make 1 L of a liquid concentrate (for root zone application) according to acceptable, preferred and most preferred embodiments of the invention, which can be diluted at a 1:50 dilution rate in water (e.g., 1 ml concentrate in 50 ml of water) to obtain a composition suitable for use:

TABLE 1

| Constituent | | | | |
|---|---|---|---|---|
| (most preferred in | | | Most | |
| parenthesis) | Acceptable | Preferred | Preferred | Optimal |
| Antioxidant | 25-1,000 | 62.5-750 | 125-375 | 250 |
| (Erythorbic Acid) | | | | |
| Osmolyte (Betaine) | 25-1,000 | 62.5-750 | 125-375 | 250 |
| Wetting Agent | 0-50 | 1-25 | 3-10 | 5 |
| (SOAX ®) | | | | |
| Emulsifier | 0-5 | 1-4 | 1.75-3.25 | 2.5 |
| (Polyoxyethylene | | | | |
| sorbitan monooleate- | | | | |
| TWEEN ® 80) | | | | |
| Preservative | 0-0.02 | 0.002-0.016 | 0.003-0.012 | 0.01 |
| (ISOCIL ® | | | | |
| RW 14) | | | | |
| Colorant (ACID | 0-0.1 | 0.008-0.08 | 0.017-0.06 | 0.05 |
| STABLE | | | | |
| AQUA 5270) | | | | |
| Water | Balance | Balance | Balance | Balance |
| Final Volume | 1 L | 1 L | 1 L | 1 L |

When the composition is provided in a ready-to-use format (or is prepared from a concentrate after appropriate dilution) for root zone application (e.g., by sub-irrigation, drip or drench), the composition preferably has the following mass ranges in grams of materials:

TABLE 2

| Constituent | | | | |
|---|---|---|---|---|
| (most preferred in | | | Most | |
| parenthesis) | Acceptable | Preferred | Preferred | Optimal |
| Antioxidant | 0.5-20 | 1.25-15 | 2.5-7.5 | 5 |
| (Erythorbic Acid) | | | | |
| Osmolyte (Betaine) | 0.5-20 | 1.25-15 | 2.5-7.5 | 5 |
| Wetting Agent | 0-1 | 0-0.5 | 0-0.2 | 0.1 |
| (SOAX ®) | | | | |
| Emulsifier | 0-0.1 | 0.02- | 0.035- | 0.05 |
| (Polyoxyethylene | | 0.08 | 0.065 | |
| sorbitan monooleate- | | | | |
| TWEEN ® 80) | | | | |
| Preservative (ISOCIL ® | 0-0.0004 | 0.00004- | 0.00006- | 0.0002 |
| RW 14) | | 0.00032 | 0.00024 | |
| Colorant (ACID | 0-0.002 | 0.00016- | 0.00034- | 0.001 |
| STABLE | | 0.0016 | 0.0012 | |
| AQUA 5270) | | | | |
| Water | Balance | Balance | Balance | Balance |
| Final Volume | 1 L | 1 L | 1 L | 1 L |

It will be appreciated that the concentration of the antioxidant and osmolyte can be higher than specified when the composition is applied at less than saturation, and additional water is then added to the plant (e.g., the composition is applied at a dosage less than saturation, and then the plant is supplied with water to achieve saturation).

When the composition is provided in a ready-to-use format (or is prepared from a concentrate after appropriate dilution) for overhead or over the plant foliar application, the composition preferably has the following mass ranges in grams of materials (a liquid concentrate for producing such a composition would obviously be adjusted such that the desired composition is obtained after dilution):

TABLE 3

| Constituent | | | |
|---|---|---|---|
| (most preferred in | | Most | |
| parenthesis) | Preferred | Preferred | Optimal |
| Antioxidant (Erythorbic Acid) | 0.1-2.5 | 0.25-1 | 0.35 |
| Osmolyte (Betaine) | 0.5-7.5 | 1-5 | 2.5 |
| Wetting Agent (SOAX ®) | 0-0.5 | 0-0.2 | 0.1 |
| Emulsifier (Polyoxyethylene | 0-0.08 | 0-0.065 | 0.05 |
| sorbitan monooleate- | | | |
| TWEEN ® 80) | | | |
| Preservative (ISOCIL ® | 0- | 0- | 0.0002 |
| RW 14) | 0.00032 | 0.00024 | |
| Colorant (ACID STABLE | 0- | 0- | 0.001 |
| AQUA 5270) | 0.0016 | 0.0012 | |
| Water | Balance | Balance | Balance |
| Final Volume | 1L | 1L | 1 L |

In a preferred method, the liquid concentrate is formed by first measuring the water, then adding the emulsifier and mixing thoroughly. Next the wetting agent is added and the solution is thoroughly mixed again. Next, the antioxidant is added to the solution and is allowed to completely dissolve. Then, the osmolyte is added to the solution and is allowed to completely dissolve. The preservative is then added and allowed to completely dissolve. The colorant is then added. When erythorbic acid and betaine are used (both of which are solids), the solids must be allowed to fully dissolve before adding the next material. It will be appreciated that the order of addition can be varied, and that components can be mixed together before being added to the water.

The liquid concentrate can generate carbon dioxide in the headspace of a container during storage at elevated temperatures (e.g. greater than 20° C.). This can result in a slight pressure buildup in the container, which can distort its shape. Therefore, it is recommended to use a container with a vent or a pressure relief valve to store the composition.

The composition is preferably applied to the root zone or growing media. The growing media can be a soilless growing media (e.g., peat based, coco based, engineered foam based) or a soil-containing growing media. As noted above, application of the composition is preferably made via sub-irrigation, drench, or drip application. But the composition can also be applied as overhead watering.

Applicant has discovered that multiple applications of the solution to the same plant provides greater benefits than a single application. For example, the composition can be applied to young plants before transplant and then again after transplant. The term “young plants” means plants that have been propagated for future transplant, either to a pot or to the field. The term “young plants” does not encompass “finished plants”, which are plants that are in a pot or container and ready for sale at retail. For young plants, the composition can be applied one or more times at any point during the production cycle prior to transplant, and can also be applied after transplant (in a pot, tray or in the field). For finished plants, the composition can be applied at least two times (i.e., multiple times). In both cases, applications are preferably spaced apart by at least 24 hours.

The composition has been seen to be especially effective in delaying wilting in the following groups of plants:
spring annual bedding and container plants, such as petunias, calibrachoas, geraniums, impatiens, etc.
Potted plants, such as poinsettias, mini roses, mums, cacti, gerberas, dahlias, etc.
Perennials, such as roses, hydrangeas, etc.
Tropical foliage plants, such as ferns, ficus, ivies, pothos, philodendrons, etc.
Tropical flowering plants, such as orchids, bromeliads, bougainvillea, mandeveilla, hibiscus, etc.
Evergreens, shrubs and other nursery and forestry crops
Seedling plugs, liners, and propagated cuttings
Food crops—potted as well as transplants of herbs and vegetables (greenhouse and field)
Industrial/medical crops such as cannabis and hemp

While the composition has been observed to be especially effective when used with the previous list of plant types, the composition can be applied to other plants types for similar results.

Although the composition is designed to alleviate water/drought stress in plants, application of the composition to plants may result in additional benefits as well. Possible additional benefits include increased chilling stress tolerance, increased heat stress tolerance, and increased tolerance to other abiotic stresses. The composition may also be effective in delaying wilting of cut flowers when added to a typical vase solution. The composition can be applied at a lower concentration with every irrigation along with or without fertilizer during the whole plant production process or last few irrigations during production process to increase the plant tolerance to abiotic stress.

The following examples are intended only to illustrate the invention and should not be construed as imposing limitations upon the claims.

### EXAMPLE 1

A liquid concentrate for forming a composition according to the present invention was prepared using the masses included in table 4 below.

TABLE 4

| Material | Mass (g) |
|---|---|
| Erythorbic Acid | 250 |
| Betaine | 250 |
| SOAX ® | 5 |
| Polyoxyethylene sorbitan monooleate | 2.5 |
| ISOCIL ® RW | 0.01 |
| ACID STABLE AQUA 5270 | 0.05 |
| Water | Balance |
| Final Volume | 1 L |

The liquid concentrate thus formed was used in all of the following examples. In each case, the liquid concentrate was diluted with deionized water at a 1:50 dilution ratio to obtain the composition used in the examples.

### EXAMPLE 2

A selection of finished poinsettia plants was purchased from a commercial grower. The plants were grown in peat-based media. Half of the poinsettias were designated as “control” poinsettias, and were watered with water only by sub-irrigation. Sub-irrigation was conducted when the soil moisture content of the pots was approximately 50%, by placing the pots in a tray with water for approximately 30 minutes to completely equilibrate the media moisture content. The other half of the poinsettias were sub-irrigated in the same manner, except that they were treated with a composition (diluted) according to Example 1. No further watering was done to either group of poinsettias after the initial treatments.

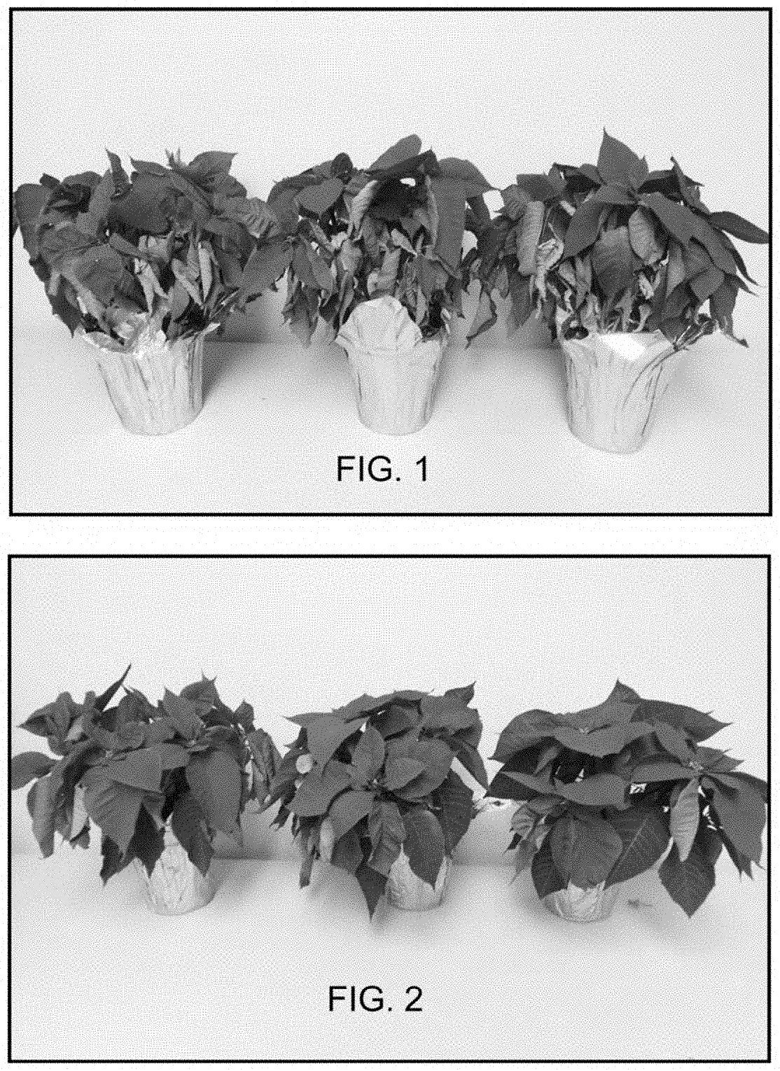

The poinsettias were left in the same greenhouse to ensure constant conditions. The temperature was maintained at about 25° C. The humidity was 50-60% and light levels were at approximately 400 μmoles/m²/sec. The number of days required for each plant to wilt was recorded. The average for the control group was 10 days before wilting was observed, while the average for the group treated with the composition according to Example 1 was 14 days before wilting was observed. FIG. 1 shows control poinsettias after 14 days of drought stress. FIG. 2 shows poinsettias treated with a composition according to the invention after 14 days of drought stress.

The change in the pot weight during the shelf life study was similar between control and treatment, however, a significant improvement in drought tolerance was observed. This data demonstrates that the composition is not impeding the water availability, but rather is modulating the plant physiology to better adapt to drought stress to maintain the plant quality.

Poinsettias treated with the composition according to Example 1 maintained quality for 14 days while the control plants lasted 10 days. This is an additional 4 days improvement in shelf life.

### EXAMPLE 3

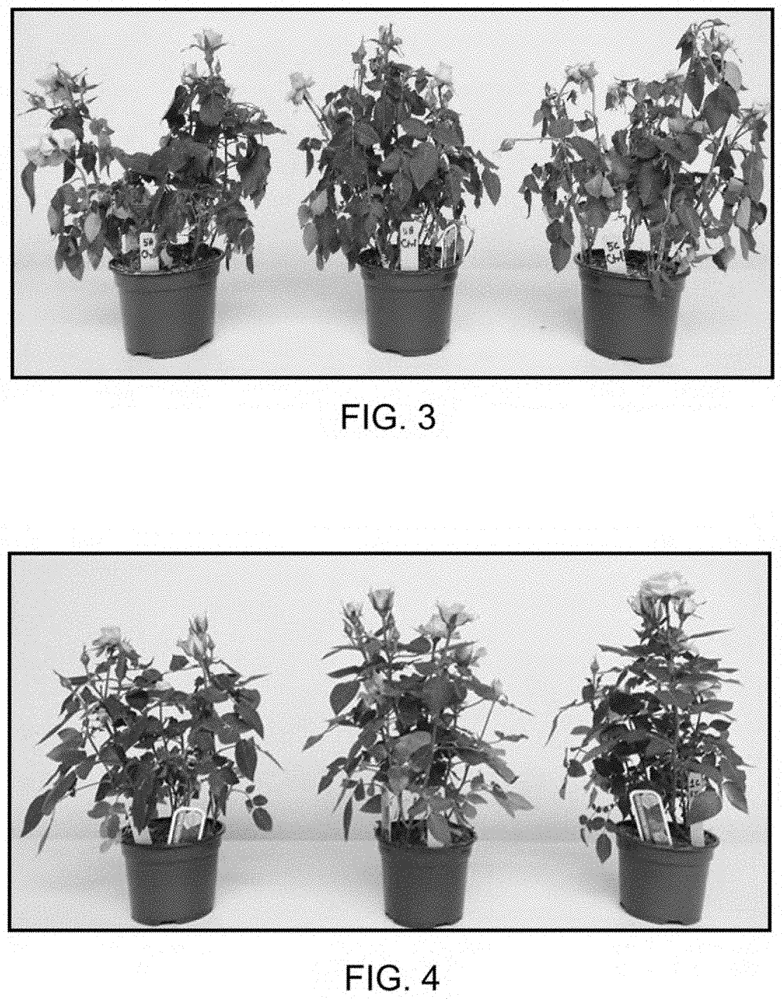

The same procedure as used in Example 2 was repeated with potted indoor roses. FIG. 3 shows indoor potted roses after 8 days of drought stress. FIG. 4 shows indoor potted roses treated with the composition according to Example 1 after 8 days of drought stress.

The change in the pot weight during the shelf life study was similar between control and treatment, however, a significant improvement in drought tolerance was observed. Potted roses treated with the inventive composition maintained quality for 7.5 days, while the control plants lasted 5 days, which is an additional 2.5 days improvement in shelf life.

### EXAMPLE 4

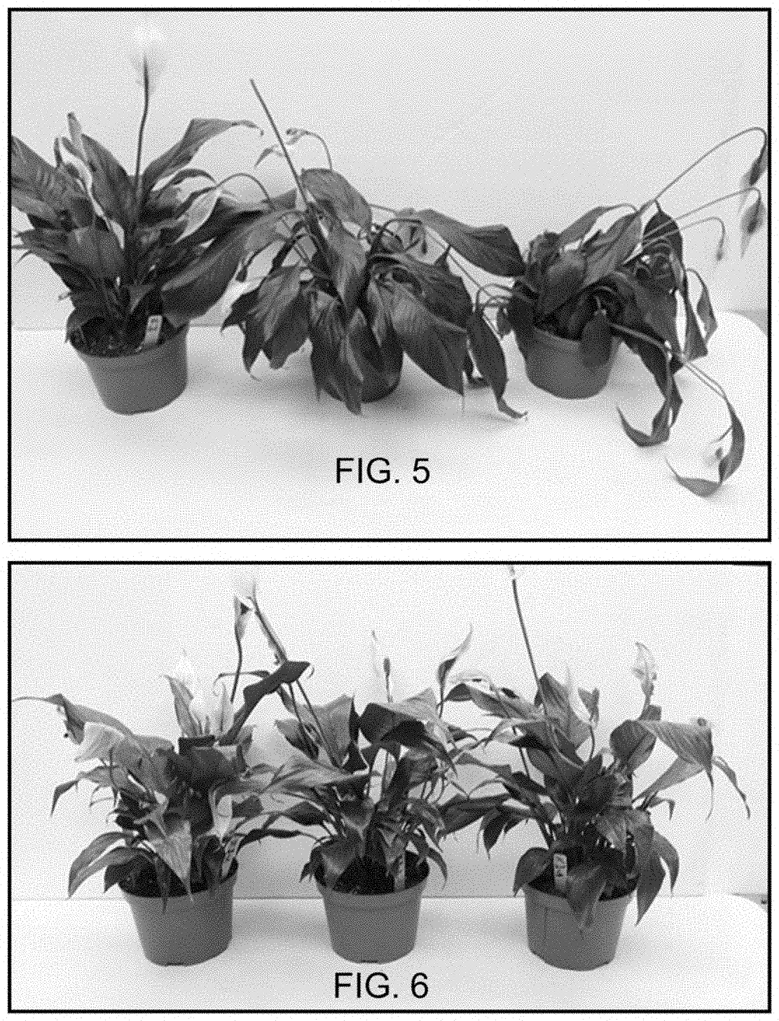

The same procedure as used in Example 2 was repeated with Spathyphyllum (Peace Lily) plants. FIG. 5 shows control Spathyphyllum after 10 days of drought stress. FIG. 6 shows Spathyphyllum treated with the the composition according to Example 1 after 10 days of drought stress.

The change in the pot weight during the shelf life study was similar between control and treatment, however, a significant improvement in drought tolerance was observed. Spathyphyllum treated with the inventive composition maintained quality for 10.5 days, while the control plants lasted 7 days, which is an additional 3.5 days improvement in shelf life.

### EXAMPLE 5

A selection of cilantro plants (4″ potted) was purchased from a commercial grower. Half of the cilantro plants were designated as “control” plants, and were watered with water only by sub-irrigation. The other half of the cilantro plants were sub-irrigated with a composition (diluted) according to Example 1. It was determined that approximately 73 ml of treatment solutions (water for control group; the composition according to Example 1 for the experimental group) were taken up by the plants. No further watering was done to either group after the initial treatments.

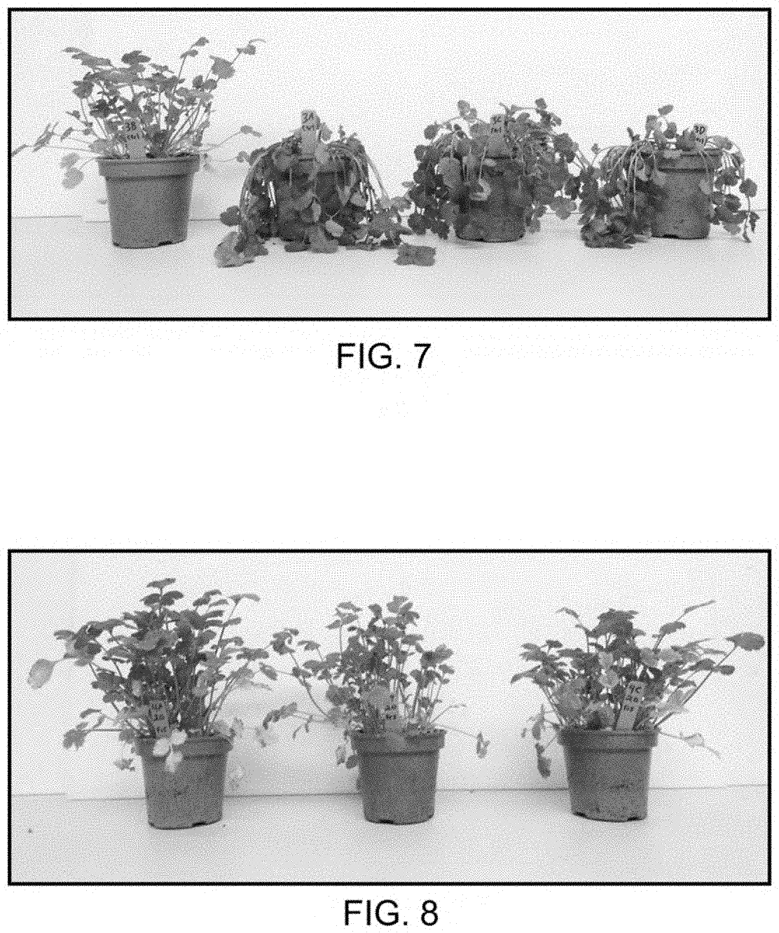

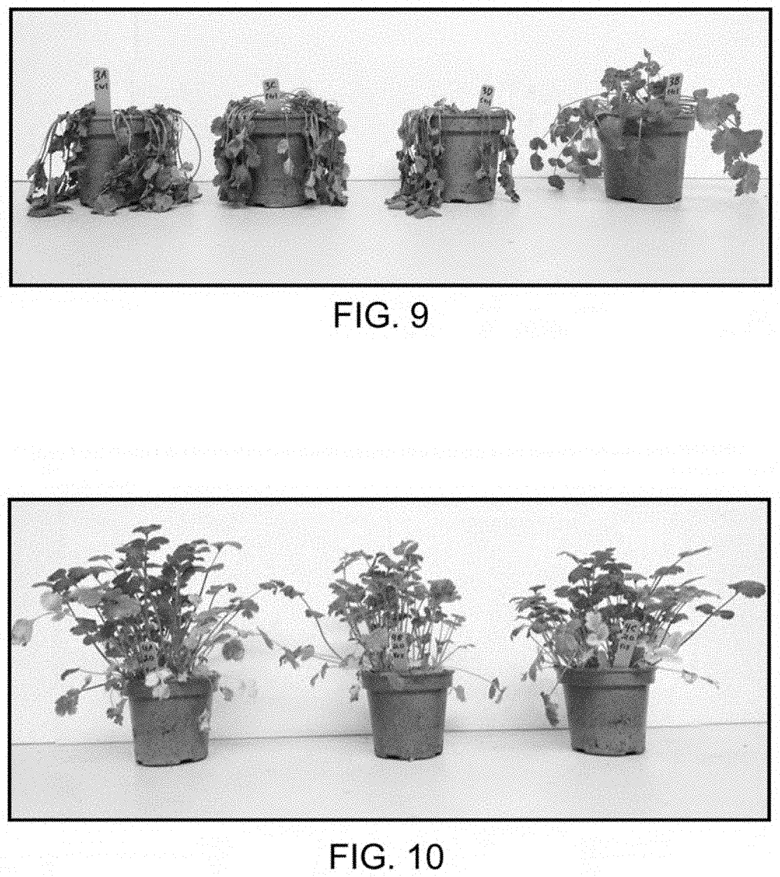

The cilantro plants were left in the same greenhouse to ensure constant conditions. FIG. 7 shows control cilantro after 4 days of drought stress. FIG. 8 shows cilantro treated with the inventive composition after 4 days of drought stress. FIG. 9 shows control cilantro after 5 days of drought stress. FIG. 10 shows cilantro treated with the inventive composition after 5 days of drought stress.

Plants in the experimental group showed a 30.13% higher pot weight compared to the control group at 5 days after treatment. After 5 days of treatment, the plants in the experimental group maintained a quality score of 6 compared to a score of 1 observed for control (Quality was rated on a 1 to 9 point scale, where 9 is a perfect, non-stressed healthy plant, and 1 is a completely wilted and stressed plant). Cilantro in the experimental group had a 2 day improvement in shelf life compared to control.

### EXAMPLE 6

A selection of spearmint plants (4″ potted) was purchased from a commercial grower. Half of the spearmint plants were designated as “control” plants, and were watered with water only by sub-irrigation. The other half of the cilantro plants were sub-irrigated with a composition (diluted) according to Example 1. It was determined that approximately 62 ml of treatment solutions (water for control group; the composition according to Example 1 for the experimental group) were taken up by the plants. No watering was done to either group after the initial treatments.

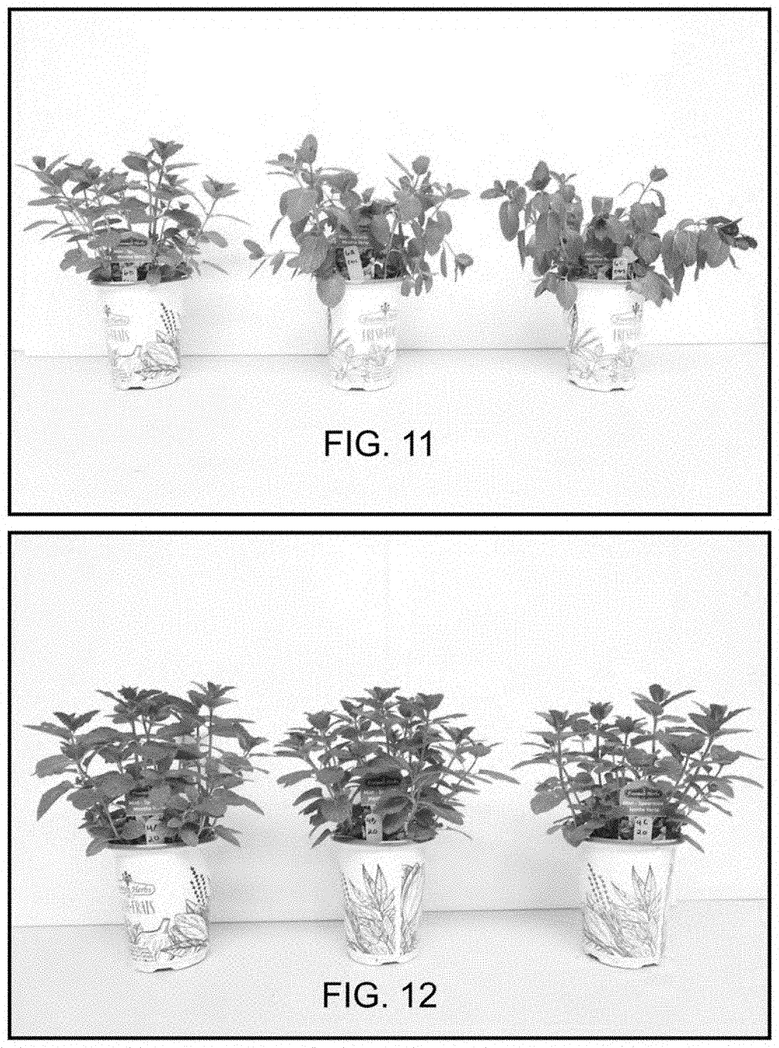

The spearmint plants were left in the same greenhouse to ensure constant conditions. FIG. 11 shows control spearmint after 4 days of drought stress. FIG. 12 shows spearmint treated with the inventive composition after 4 days of drought stress.

Plants in the experimental group showed a 16.64% higher pot weight compared to the control group at 4 days after treatment. 4 days after treatment, the plants in the experimental group maintained a quality score of 9 compared to a score of 5.3 observed for control. 6 days after treatment, the plants in the experimental group maintained a quality score of 5 compared to a score of 1.3 observed for control. Spearmint in the experimental group had a 2 day improvement in shelf life compared to control.

### EXAMPLE 7

A selection of basil plants (4″ potted) was purchased from a commercial grower. Half of the basil plants were designated as “control” plants, and were watered with water only by sub-irrigation. The other half of the basil plants were sub-irrigated with a composition (diluted) according to Example 1. It was determined that approximately 236 ml of treatment solutions (water for control group; the composition according to Example 1 for the experimental group) were taken up by the plants. No watering was done to either group after the initial treatments.

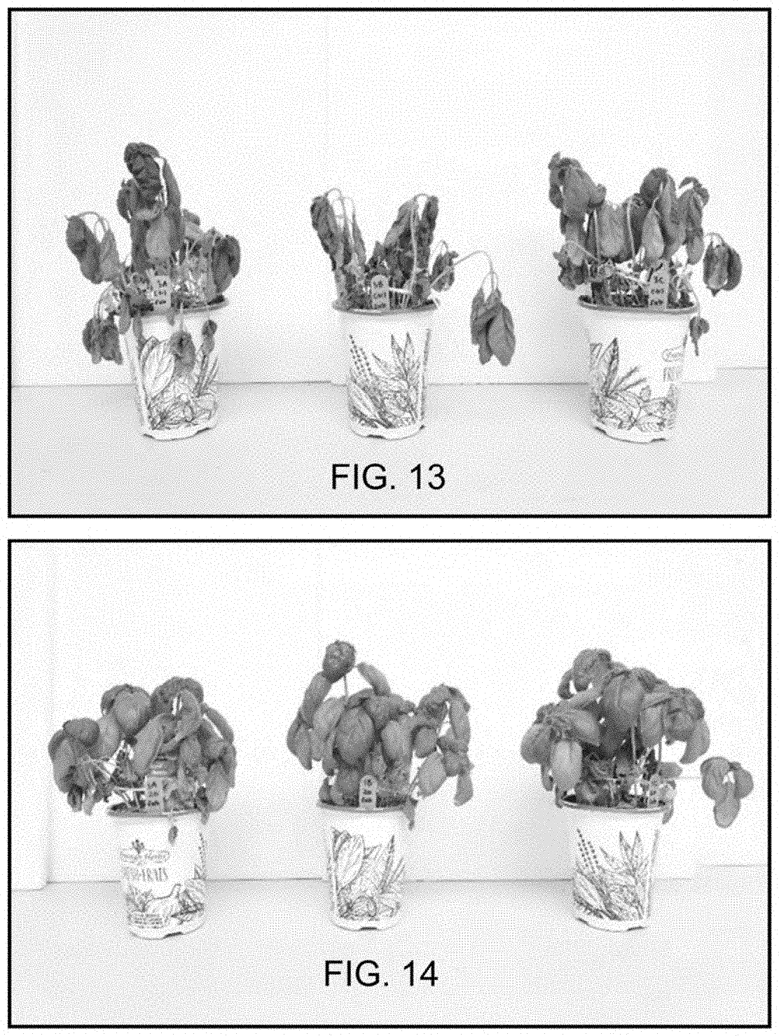

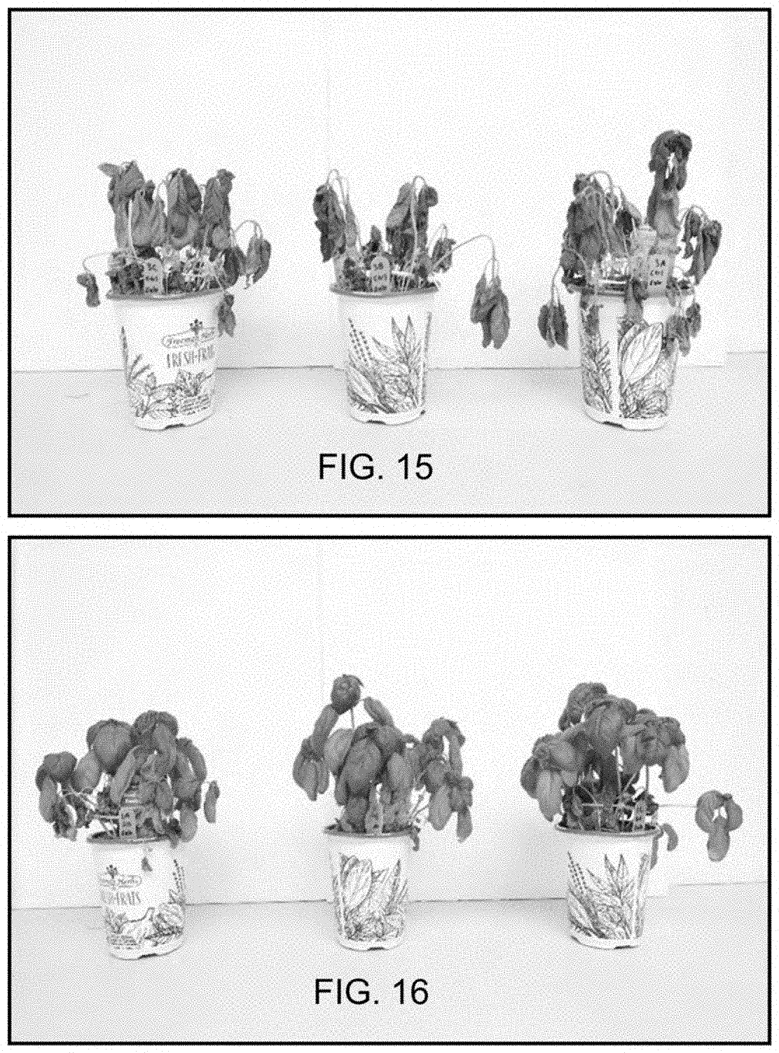

The basil plants were left in the same greenhouse to ensure constant conditions. FIG. 13 shows control basil after 9 days of drought stress. FIG. 14 shows basil treated with the inventive composition after 9 days of drought stress. FIG. 15 shows control basil after 10 days of drought stress. FIG. 16 shows basil treated with the inventive composition after 10 days of drought stress.

Plants in the experimental group showed a 36.29% higher pot weight compared to the control group at 9 days after treatment. 9 days after treatment, the plants in the experimental group maintained a quality score of 5.3 compared to a score of 1 observed for control. Basil in the experimental group had a 2.3 day improvement in shelf life compared to control.

### EXAMPLE 8

A selection of two different poinsettia cultivars (“Christmas Spirit” and “Maren”) were purchased as rooted cuttings (liners) from a greenhouse. The cuttings were rooted in engineered foam growing media (Rootcubes Wedge manufactured by Smithers Oasis). Half of each cultivar were designated as “control” plants, and were watered with water by sub-irrigation. The other half were sub-irrigated with a composition (diluted) according to Example. No further watering was done to either group after the initial treatments.

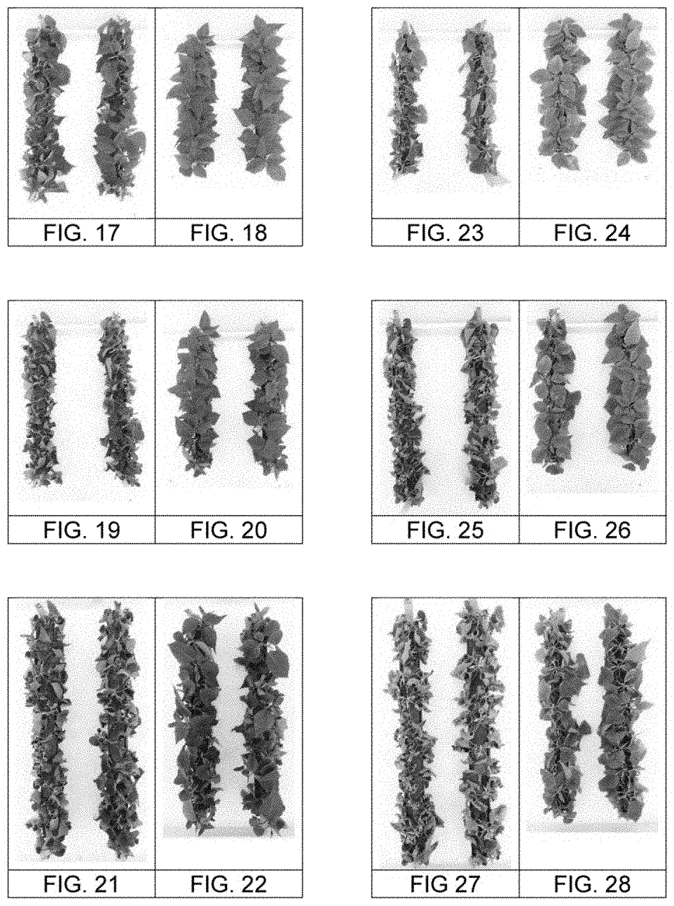

The poinsettia rooted cuttings were left in the same greenhouse to ensure constant conditions. FIG. 17 shows control “Christmas Spirit” poinsettia rooted cuttings four days after watering. FIG. 18 shows “Christmas Spirit” poinsettia rooted cuttings treated with the inventive composition four days after watering. FIG. 19 shows control “Christmas Spirit” poinsettia rooted cuttings five days after watering. FIG. 20 shows “Christmas Spirit” poinsettia rooted cuttings treated with the inventive composition five days after watering. FIG. 21 shows control “Christmas Spirit” poinsettia rooted cuttings six days after watering. FIG. 22 shows “Christmas Spirit” poinsettia rooted cuttings treated with the inventive composition six days after watering. FIG. 23 shows control “Maren” poinsettia rooted cuttings four days after watering. FIG. 24 shows “Maren” poinsettia rooted cuttings treated with the inventive composition four days after watering. FIG. 25 shows control “Maren” poinsettia rooted cuttings five days after watering. FIG. 26 shows “Maren” poinsettia rooted cuttings treated with the inventive composition five days after watering. FIG. 27 shows control “Maren” poinsettia rooted cuttings six days after watering. And, FIG. 28 shows “Maren” poinsettia rooted cuttings treated with the inventive composition six days after watering.

All plants were evaluated for quality using a scale of 1-5 (1: worse, 5=Best). The percentage of rooted cuttings with a score of 3 or above was calculated and represented the tables below:

TABLE 5
Poinsettia “Christmas Spirit”

| | % of Plants With Score of 3 or Higher | | |
|---|---|---|---|
| | 4 Days | 5 Days | 6 Days |
| Control | 30 | 0 | 0 |
| Inventive | 100 | 90 | 50 |

TABLE 6
Poinsettia “Maren”

| | % of Plants With Score of 3 or Higher | | |
|---|---|---|---|
| | 4 Days | 5 Days | 6 Days |
| Control | 10 | 0 | 0 |
| Inventive | 100 | 100 | 40 |

Treatment with the inventive composition improved the shelf life of both cultivars of poinsettia rooted cuttings under water stress. The improvement was evident in foam media (Rootcube Wedge). It appears that foam media may better facilitate the uptake of the inventive composition to the plants, which promoting better stress tolerance, as compared to organic media.

### EXAMPLE 9

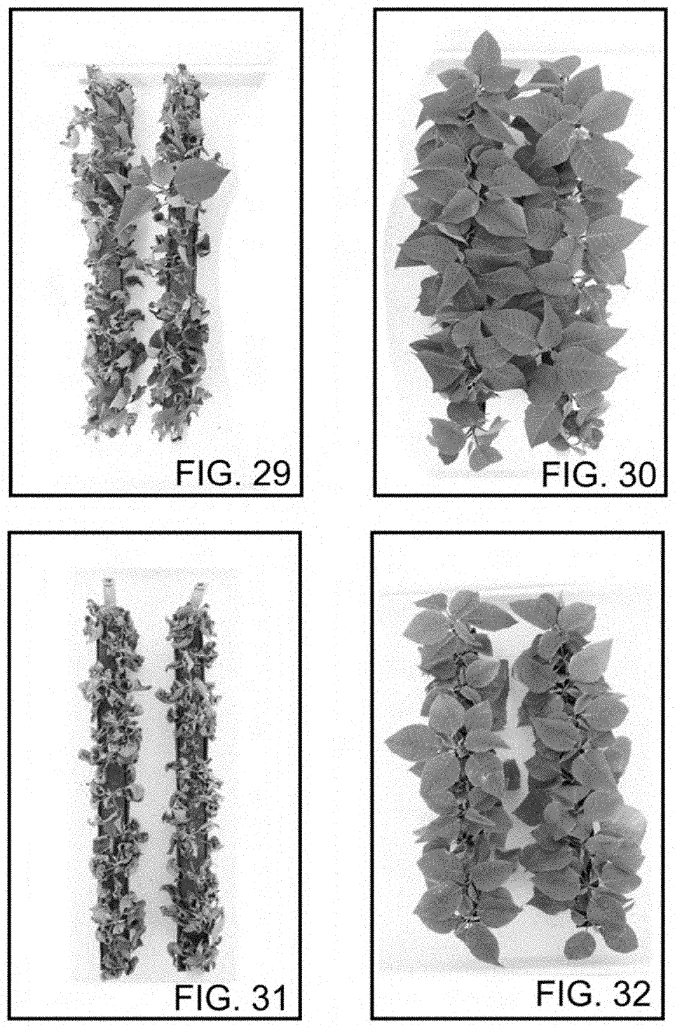

The poinsettia rooted cuttings from Example 8 above were re-watered (with water only) after 6 days of drought stress. FIG. 29 shows the control “Christmas Spirit” poinsettia rooted cuttings shown in FIG. 21 one day after re-watering. FIG. 30 shows the “Christmas Spirit” poinsettia rooted cuttings treated with the inventive composition shown in FIG. 22 one day after re-watering. FIG. 31 shows the control “Maren” poinsettia rooted cuttings shown in FIG. 27 one day after re-watering. And, FIG. 32 shows the “Maren” poinsettia rooted cuttings treated with the inventive composition shown in FIG. 28 one day after re-watering. The control plants could not absorb any water, and remained wilted. However, the plants that were treated with the inventive composition could absorb water and became turgid.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1. A composition for application to the root zone of growing plants, said composition comprising an antioxidant and an osmolyte, both dissolved in water, wherein:
the antioxidant and the osmolyte are present in the composition at a weight ratio relative to each other of from about 40:60 to about 60:40;
the antioxidant is present in the composition in an amount of from about 0.5 to about 20 grams per liter;
the osmolyte is present in the composition in an amount of from about 0.5 to about 20 grams per liter;
the antioxidant is one or more selected from the group consisting of: (a) erythorbic acid and isomers and salts thereof; (b) ascorbic acid and isomers and salts thereof; (c) dehydroascorbic acid; and glutathione; and
the osmolyte is one or more selected from the group consisting of: (a) betaine (N, N, N-trimethylglycine); (b) proline; and (c) glycine.

2. The composition according to claim 1, wherein the antioxidant is erythorbic acid and the osmolyte is betaine (N, N, N-trimethylglycine).

3. The composition according to claim 2, wherein the composition further comprises gamma-aminobutyric acid.

4. The composition according to claim 3, wherein the composition further comprises a non-ionic surfactant.

5. The composition according to claim 4, wherein the non-ionic surfactant is a polyoxypropylene-polyoxyethylene block copolymer.

6. A method for improving the drought tolerance and/or the chilling stress tolerance of a growing plant, the method comprising applying a composition according to claim 1 to the root zone of the growing plant.

7. The method according to claim 6, wherein the antioxidant in the composition is erythorbic acid and the osmolyte in the composition is betaine (N, N, N-trimethylglycine).

8. The method according to claim 7, wherein the growing plant is a finished plant or a young plant propagated from a cutting or seed.

9. The method according to claim 8, wherein the root zone of the plant is in a soilless growing media.

10. The method according to claim 1, wherein the composition is applied to the plant at least two times, said at least two times being spaced apart by at least 24 hours.

11. A composition for application to the root zone of growing plants, said composition comprising an antioxidant and an osmolyte, both dissolved in water, wherein:
the antioxidant and the osmolyte are present in the composition at a weight ratio relative to each other of from about 10:90 to about 30:70;
the antioxidant is present in the composition in an amount of from about 0.1 to about 2.5 grams per liter;
the osmolyte is present in the composition in an amount of from about 0.5 to about 4.5 grams per liter;
the antioxidant is one or more selected from the group consisting of: (a) erythorbic acid and isomers and salts thereof; (b) ascorbic acid and isomers and salts thereof; (c) dehydroascorbic acid; and glutathione; and
the osmolyte is one or more selected from the group consisting of: (a) betaine (N, N, N-trimethylglycine); (b) proline; and (c) glycine.

12. The composition according to claim 11, wherein the antioxidant is erythorbic acid and the osmolyte is betaine (N, N, N-trimethylglycine).

13. The composition according to claim 12, wherein the composition further comprises gamma-aminobutyric acid.

14. The composition according to claim 13, wherein the composition further comprises a non-ionic surfactant.

15. The composition according to claim 14, wherein the non-ionic surfactant is a polyoxypropylene-polyoxyethylene block copolymer.

16. A method for improving the drought tolerance and/or the chilling stress tolerance of a growing plant, the method comprising applying a composition according to claim 11 overhead to the growing plant.

17. The method according to claim 16, wherein the antioxidant in the composition is erythorbic acid and the osmolyte in the composition is betaine (N, N, N-trimethylglycine).

18. The method according to claim 17, wherein the growing plant is a finished plant or a young plant propagated from a cutting or seed.

19. The method according to claim 18, wherein a root zone of the plant is in a soilless growing media.

20. The method according to claim 11, wherein the composition is applied overhead to the plant at least two times, said at least two times being spaced apart by at least 24 hours.
